(19) United States
(12) Patent Application Publication
(10) Pub. No.: US 2025/0315016 A1
(43) Pub. Date: Oct. 9, 2025

(54) ENERGY YIELD MANAGEMENT SOFTWARE SYSTEM FOR INDUSTRIAL GRADE SOLAR MICROGRIDS AND CRITICAL INFRASTRUCTURE

(71) Applicants: AMIT CHOUDHURY, TORONTO (CA); LORAN FRIEDRICH, PORTLAND, OR (US)

(72) Inventors: AMIT CHOUDHURY, TORONTO (CA); LORAN FRIEDRICH, PORTLAND, OR (US)

(21) Appl. No.: 18/974,821

(22) Filed: Dec. 10, 2024

Related U.S. Application Data
(63) Continuation-in-part of application No. 18/138,121, filed on Apr. 23, 2023, now Pat. No. 12,316,270.
(60) Provisional application No. 63/334,660, filed on Apr. 25, 2022.

(51) Int. Cl. G05B 13/02

(52) U.S. Cl. CPC G05B 13/0265

(57) ABSTRACT

In one aspect, a computerized system of an Energy Yield Management Software (EYMS) framework includes an Industrial Grade Solar Microgrids (IGSM) deployment comprising a control unit configured to communicate with a power generating source, collect data from the power generating source, and issue instructions to the power generating resource. The control unit is further configured to communicate with a sensor, an automation module, a local load, an energy storage systems, or a generation resource within a customer IGSM deployment. The EYMS is configured to communicate through a communication network to the IGSM deployment. A Digital Twin configured to actively use real time and historical data to learn how each component in the IGSM performs under a plurality of operational conditions and characteristics, wherein a predictive model is employed by the Digital Twin for a prediction operation, an optimization operation and a prescriptive maintenance operation of the IGSM.

### CLAIM OF PRIORITY

This patent application claims priority and is a continuation in part of U.S. patent application Ser. No. 18/138,121, filed on Apr. 23, 2023 and titled SOLAR AXIS TRACKING SYSTEM FOR PORTABLE CONTAINER UNIT WITH RETRACTABLE PHOTOVOLTAIC SOLAR PANELS. This patent application is hereby incorporated by reference in its entirety.

U.S. patent application Ser. No. 18/138,121 claims priority to U.S. Provisional Patent Application No. 63/334,660, filed on 25 Apr. 2022 and titled CONTAINER UNIT WITH RAPIDLY DEPLOYABLE INTEGRATED RETRACTABLE PHOTOVOLTAIC SOLAR PANELS, BATTERIES, CONTROLLER AND ENERGY YIELD MANAGEMENT SOFTWARE. This provisional patent application is hereby incorporated by reference in its entirety.

### FIELD OF INVENTION

This invention is related to rapidly deployable solar energy systems, and more specifically for energy yield management software platform integrating real time monitoring, control and optimization of energy production, storage and consumption of Industrial Grade Solar Microgrids (IGSM) and/or similar renewable energy generation, storage and consumption resources.

### BACKGROUND

The concept of using software control systems to monitor and control the distribution of energy between renewable energy sources, energy storage systems, local loads and the utility grid has been in the market for more than 20 years. In almost all cases, the software control systems are intended to manage Distributed Energy Resources (DERs) and are often collectively referred to as Distributed Energy Resource Management Systems (DERMS). DERMS are control systems designed to manage and optimize the operation of distributed energy resources such as solar panels, wind turbines, battery storage, electric vehicles, and other decentralized power generation assets.

DERMS can enable utilities and grid operators to integrate, monitor, and control these diverse energy resources, ensuring stability, reliability, and efficiency of the power grid. They also facilitate demand response, load balancing, and energy optimization by leveraging real-time data and predictive analytics, enhancing the overall performance and sustainability of the energy system. DERMS may not be typically designed to be used by end users such as Commercial and Industrial (C&I) customers who wish to become independent from the grid and less reliant on utilities or for remote operations. The software control systems can be focused on operational control, monitoring and alarms. They may use a black box or fixed model to provide some projections.

### BRIEF SUMMARY OF THE INVENTION

In one aspect, a computerized system of an Energy Yield Management Software (EYMS) framework includes an Industrial Grade Solar Microgrids (IGSM) deployment comprising a control unit configured to communicate with a power generating source, collect data from the power generating source, and issue instructions to the power generating resource. The control unit is further configured to communicate with a sensor, an automation module, a local load, an energy storage system, or a generation resource within a customer IGSM deployment. The EYMS is configured to communicate through a communication network to the IGSM deployment. A Digital Twin configured to actively use real time and historical data to learn how each component in the IGSM performs under a plurality of operational conditions and characteristics, wherein a predictive model is employed by the Digital Twin for a prediction operation, an optimization operation and a prescriptive maintenance operation of the IGSM.

### BRIEF DESCRIPTION OF THE DRAWINGS

The present application can be best understood by reference to the following description taken in conjunction with the accompanying figures, in which like parts may be referred to by like numerals.

FIG. 1 illustrates Energy Yield Management Software (EYMS) framework, according to some embodiments.

FIG. 2 is a diagram illustrating the components of the system implementing fleet microgrid aggregation, according to some embodiments.

FIG. 3 is a diagram illustrating the components of a digital, according to some embodiments.

FIG. 4 illustrates an example IGSM optimization framework, according to some embodiments.

FIG. 5 is a diagram illustrating the prescriptive maintenance framework, according to some embodiments.

FIG. 6 is a diagram illustrating the IGSM design proposal framework, according to some embodiments.

FIG. 7 is a diagram illustrating Bayesian update model parameters with projection, according to some embodiments.

FIG. 8 illustrates an example modelling of environmental classifiers and model(s), according to some embodiments.

FIG. 9 illustrates an example modelling of local electrical load classifiers and model(s), according to some embodiments.

FIG. 10 illustrates an example battery energy storage system component, according to some embodiments.

The Figures described above are a representative set and are not an exhaustive set with respect to embodying the invention.

### DESCRIPTION

Disclosed are a software system platform and method for energy yield management and financial performance of individual, multiple or multiple sites (a fleet), of rapidly deployable integrated photovoltaic solar panels, batteries, controller system on a container unit or other structures such as low-load bearing roofs, among others, known as an Industrial Grade Solar Microgrid (IGSM).

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principals defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The details of one or more variations of the subject matter described herein are set forth in the accompanying drawings as illustrated and the description below. Other features and advantages of the subject matter herein will be apparent from the description and drawings, and from the claims.

### Example Definitions

Electrical utility can be a service provider that generates, transmits, and distributes electrical power to residential, commercial, and industrial customers, ensuring reliable and regulated energy supply through an interconnected grid system.

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning.

### Example System

This invention includes advanced energy yield management algorithms to optimize allocation of local power generation to local loads and storage, minimize energy losses, maximize financial objectives and enhance efficiency. Uniquely, this invention enables planners, operators and financial decision makers to dynamically set energy and financial yield objectives with relative priority. Discussed herein are the details of the multiple objectives and how they are implemented to generate up to date and effective control instructions to IGSM or similar deployments. In concert with the platform's optimization algorithms, the platform employs a system's digital twin with real time updated models of component hardware and local energy generation and consumption patterns. The digital twin is the foundational calculator for energy yield optimization, prescriptive maintenance tools, and maintenance schedulers.

This invention emphasizes the use and effectiveness of financial instruments, e.g., grants, loans and incentive programs, which are available and applicable for each deployment. Financial strategies and performance expected from IGSM, or similar deployments are determined, calculated and presented to the planner, operator and financial decision maker. The performance of investment into IGSM or similar deployments is constantly reviewed, calculated and presented to operators on an accessible dashboard interface, enabling future planning and immediate reporting of energy yield and investment status. Further, this invention continuously (e.g. calculated at a predetermined interval of no more than one hour) calculates the ongoing future expectation of investment and capital performance for individual sites as well as fleets of deployments for a period of no less than 30 years.

This invention features novel time series prediction algorithms to enable robust and accurate predictions of features such as energy consumption, environmental conditions and energy generation over 24 to 48-hour look ahead at 15-minute (or similar) intervals, for example. The methodologies described herein incorporate multiple stages of modeling including advanced and interconnected classification of environmental factors, site and occupant behaviors, seasonality, and intraday variability, inter alia, in conjunction with real time model selection and prediction updating. The methodologies described herein enable accurate time series modeling that is real-time adaptive and specific to individual sites.

Example embodiments feature detailed and comprehensive past 24-hour analysis of IGSM and related components' performance due to computed control instructions versus predicted expectations, which is stored. This performance report enables immediate view into the effectiveness of the components of the digital twin, optimization algorithm and objectives.

Future predictions of the state of each component within a IGSM or similar deployment are calculated at intervals of no more than one hour, though typically every 15-minute period. The system calculates each components' performance based upon time series prediction of environmental and energy consumption models, and continuously updated models of hardware components. The system simulates the interactions between all components which in turn are used by multi-objective optimization algorithms to enact optimal energy yield and financial performance of the IGSM or similar deployments.

Example embodiments calculate energy and financial yields through the modeling of time series and hardware model predictions for individual components which in turn are aggregated to a site level operational plan and performance monitoring. Subsequently, each site performance is aggregated across multiple sites and deployments which form a fleet of IGSM or similar deployments which in turn is collected to demonstrate and report on the system's effectiveness of meeting energy yield and financial objectives. Financial investment performance for each site and the aggregate of all sites into a fleet are calculated on specified intervals (of no less than one-hour intervals) and presented in a user interface dashboard. Investment and capital performance across the entire fleet of deployments, including historical, present and future performance is calculated and provided to planners, operators and decision makers in an intuitive and navigable interface. Additionally, power loss events resulting from utility outages, etc., can be modeled and resilience programs demonstrated.

This invention provides a comprehensive simulation platform to calculate the energy yield and financial performance of an IGSM or similar deployments enabling financial and physical planning in the design processes. Using historical data on environmental factors, energy consumption and utility tariffs, etc., the platform simulates the operation of a single or multiple deployments for at least one year. The operator or planner can configure the system with expected energy yield and financial objectives and relative priorities. The system generates reports detailing the optimal system design strategy for each deployment which can be used to prioritize and plan deployment and investment details.

This invention describes the interaction of data collection, digital twin, and energy yield and financial optimization algorithms with external energy market and utility programs, such as demand response for example. In some embodiments of this invention, interactions with real time and predicted energy market forces are considered in the optimization objectives and operational control planning. For example, in some embodiments, the customer may enroll one or more specific deployment sites in a utility's demand response program. This invention will enable acting on signals received by a utility to manage local energy resources including generation and storage to meet the demand response requests. Energy pricing, both instant and predicted, can in some embodiments of this invention be used to determine when and how much energy is used locally, sent back to the utility grid or used to charge local storage from the grid.

This invention enables planners and operators to prepare for various crises management scenarios including but not limited to unexpected loss of power, predicted power loss or intermittent unavailable (for instance due to inclement weather events), and other utility related issues, such as loss of transmission, generation or delivery events for deployed sites individually or across some or all of their fleet.

Additionally, the system features intuitive dashboards for visualizing key metrics such as operational performance data, present and predicted financial performance and system status, enabling operators to make informed decisions and ensure reliable, sustainable and effective energy management while meeting specified environmental, energy yield and financial objectives. Further, the present embodiment of this platform accounts for and details relevant information on fleet level aggregations of disparate IGSM or similar deployments across multiple locations, owned and operated by a single customer with the ability for an administrator with specific rights and privileges to aggregate information across multiple customers, sometimes referred to as multiple tenants.

Example embodiments can provides systems, techniques, and computer program products to aggregate into a single platform the historical, present and predicted future status of financial performance, and energy yield of IGSM or similar deployments. Additionally, the subject matter herein provides computer program products to monitor and report on system state and alarms, system security and protection and systems maintenance scheduling of IGSM products.

In some embodiments, the platform can monitor and control heating and cooling elements of an IGSM based upon the seasonal environment (e.g. winter cold, summer heat). In other embodiments, the platform will implement hardware protection algorithms by, for example, retracting IGSM panels to protect from forecasted inclement weather or to retract panels when not producing power to protect from vandalism or other types of impediments. In some embodiments, the platform can monitor security events and may activate local auditory warnings or enable monitoring of camera feeds.

Architecture, cloud-platform implementations and supervisory control are now discussed.

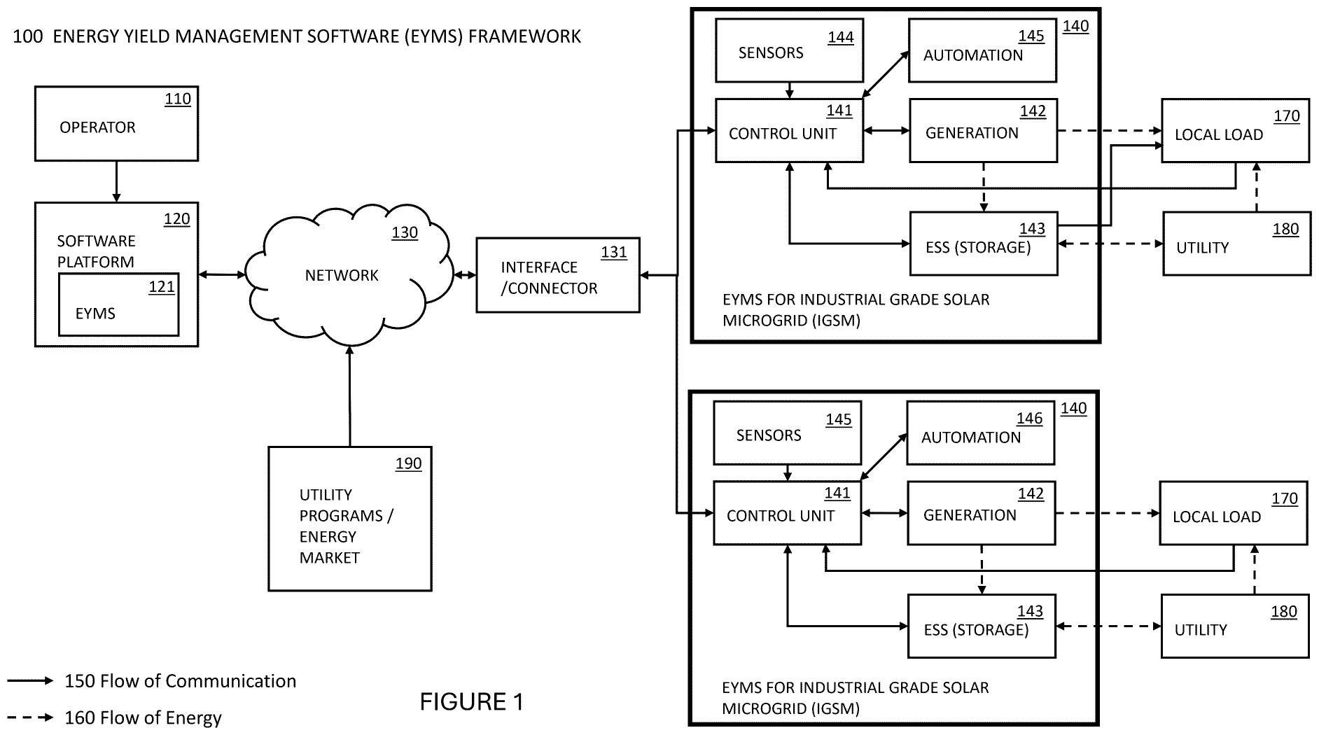

FIG. 1 illustrates Energy Yield Management Software framework illustrating a system for real time Industrial Grade Solar Microgrids (IGSM) or similar deployments, monitoring and control which includes a communication system among a customer device(s) at an operator 110, a real time energy yield management and optimization system (EYMS) 121 within the software platform 120. As used herein, real time can take into account processing latencies, network latencies, etc.

The EYMS 121 communicates through a communication network 130 (e.g., the internet, a secure communications network, a wireless network, a combination of the foregoing, etc.) to various embodiments of IGSM deployments 140.

An IGSM deployment 140 may have a control unit 141 communicating, collecting data, and issuing instructions to power generating resources 142 (e.g. solar PV, hydrogen fuel cells, diesel generators, etc.), local loads (e.g. or any equipment location served by the electrical grid) 170 and energy storage systems 143, including but not limited to battery energy storage systems, among others.

The software in the IGSM includes control units 141 which communicate with sensors 144, automation 145, local load 170, which may be located at a point beyond the customer meter (e.g. the meter used by the utility 180), energy storage systems 143, or generation resources 142, within a customer IGSM deployment.

Utility 180 can be an electrical utility is a service provider that generates, transmits, and distributes electrical power to residential, commercial, and industrial customers, ensuring reliable and regulated energy supply through an interconnected grid system.

Each control unit 141 can include at least one processor and memory storing instructions causing data to be transmitted to one or more connected resources to cause the transfer of energy between the grid, local renewable power generation sources, local energy storage (e.g. battery systems) and local energy demand to selectively change.

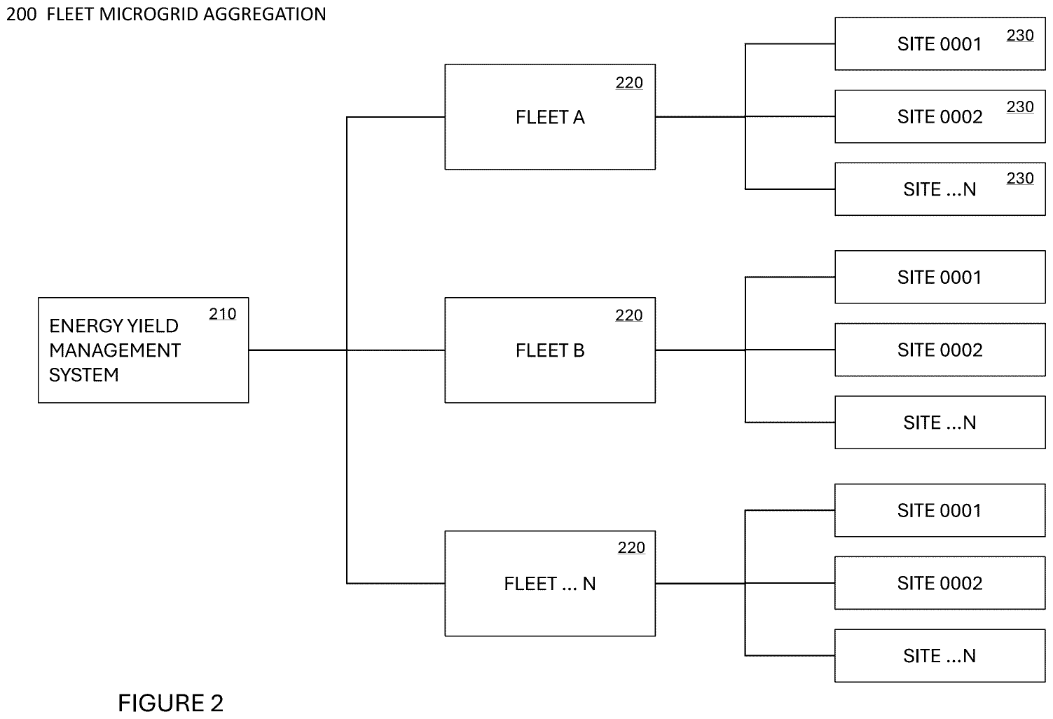

FIG. 2 is a diagram illustrating the components of the system implementing fleet microgrid aggregation, according to some embodiments. The EYMS system 210 manages multiple fleets, 220, each consisting of one or more sites 230, where a fleet represents a collection of geographically distributed or functionally related sites. The EYMS system 210 enables centralized monitoring, control, and optimization of operations across these sites, allowing for efficient resource management, data collection, and real-time decision-making for the entire fleet.

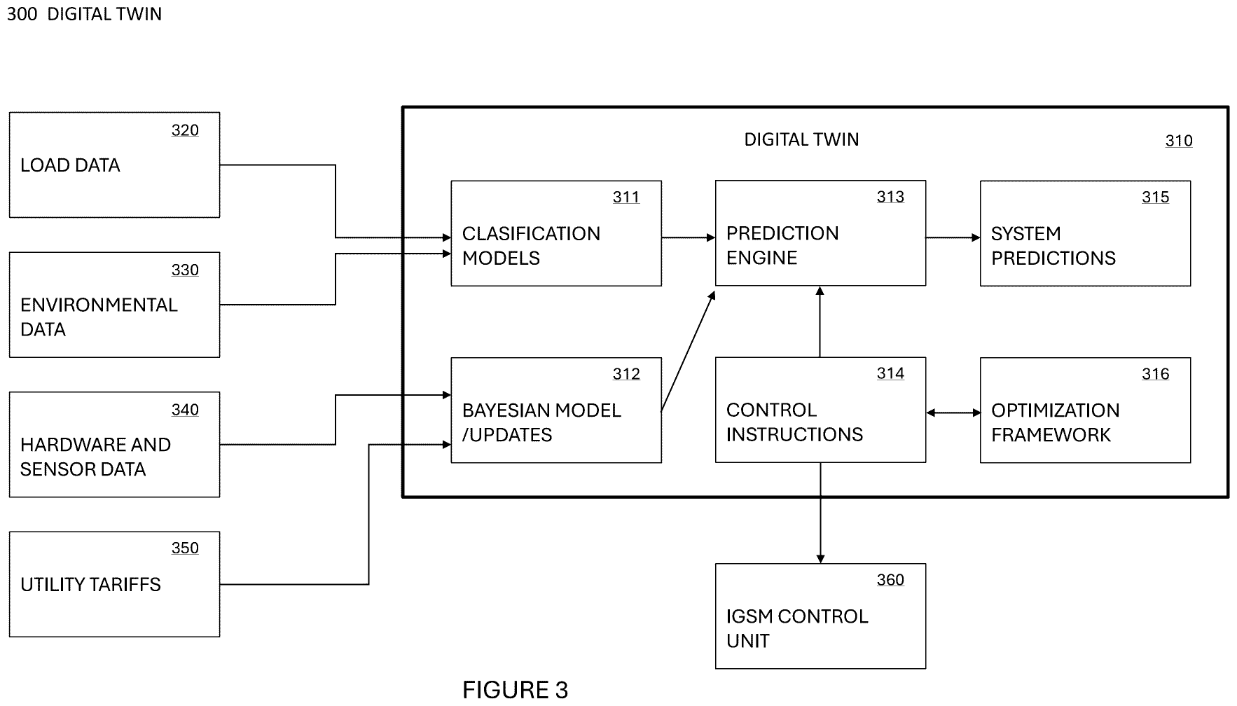

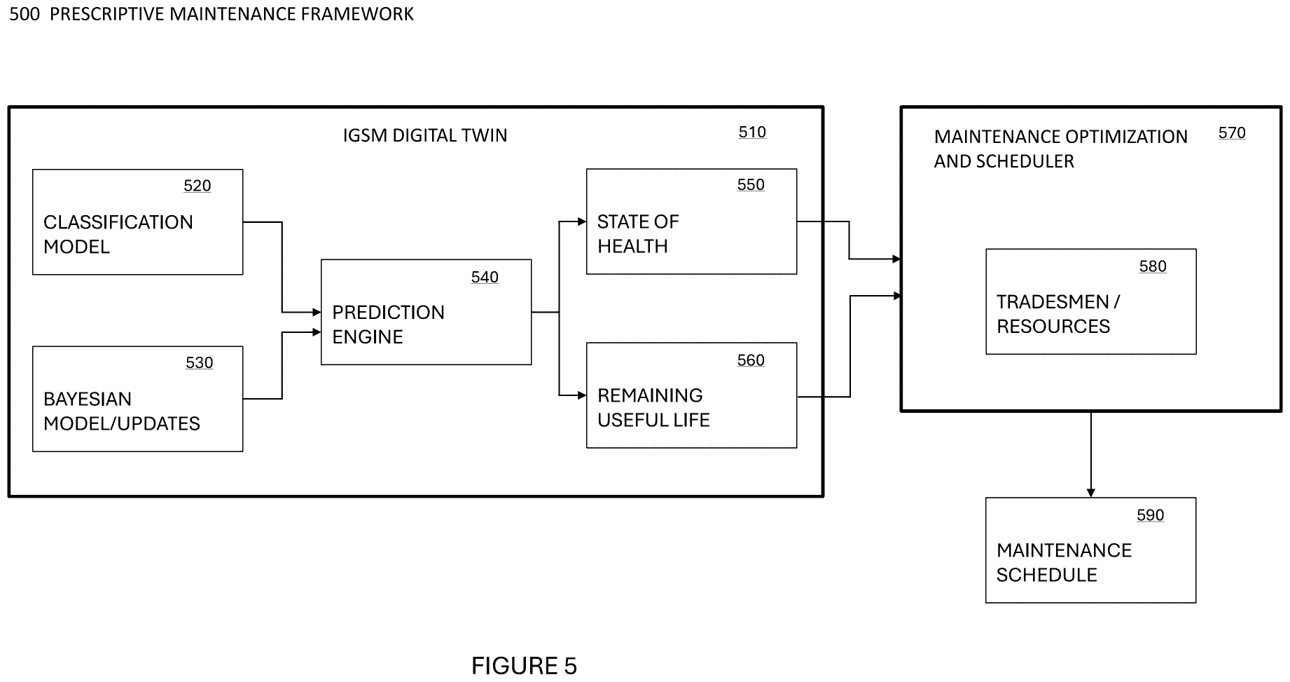

Digital twin and modeling are now discussed. FIG. 3 is a diagram illustrating the components of a digital twin including required data inputs, framework and resulting control instructions, according to some embodiments. Digital twin 300 can include intelligence to actively use real time and, where available, historical data 320, 330 and 340 to learn how each physical component in the IGSM or similar deployment performs under a variety of operational conditions and characteristics. The predictive models are employed by the platform's digital twin 300 to render system-wide prediction of hardware operation and energy yield 315 used by optimization, and prescriptive maintenance 570 algorithms (e.g. illustrated in FIG. 5). The type of model and methodology for initializing, configuring and updating for each of the various hardware components are discussed herein.

The present platform embodiment features a comprehensive digital twin 300 of IGSM or similar deployments which models each of the contributing resources (e.g. power generation, storage, consumption, etc.), environment and financial contributors. The present embodiment of the platform digital twin features, among other methodologies, real-time updateable (e.g. Bayesian, etc.) modeling 312 and classification modeling 311 to continuously and dynamically improve the accuracy of predictions and diagnostics related to hardware components and behavior patterns of a system. By incorporating both direct observations (e.g. real-time data, etc.) and historical data 320, 340, 350, Bayesian models offer a robust framework for decision-making and model development under uncertainty. This approach is particularly useful in the present platform as the IGSM, and similar deployments are comprised of complex systems where the operating conditions and behavior of components may change over time.

An example embodiment of digital twin models features adaptive learning as more data becomes available, making it more accurate over time. The models incorporate parameter uncertainty, providing probabilistic predictions that help in better prediction, and risk management. Particularly, Bayesian modeling 312 is used to monitor and predict the performance of each of the hardware components within or comprising a fleet of resources. As these resources operate under different environmental and power conditions, data on their performance is continuously collected. The Bayesian model 312 updates in real-time, providing the ability to accurately predict short term performance 315 and providing insights into which resources require immediate intermittent or replacement maintenance 570, which ones are operating efficiently, and when maintenance should be scheduled 590.

The present embodiment of digital twin models features classification algorithms 311 which allocate daily environmental 330 and load consumption 320 data into distinct classifications and patterns. This disaggregation of both data and models into classes further enhances the robustness of time series predictions for future/daily loads that are dependent upon occupant behaviors, daily and weekly consumption patterns and environmental conditions.

The present embodiment of the digital twin employs environmental forecasts and the trained component models to simulate the states and interactions of each, and between each component, therein, employing robust simulation to predict the state of the system, and each component as a function of time 315.

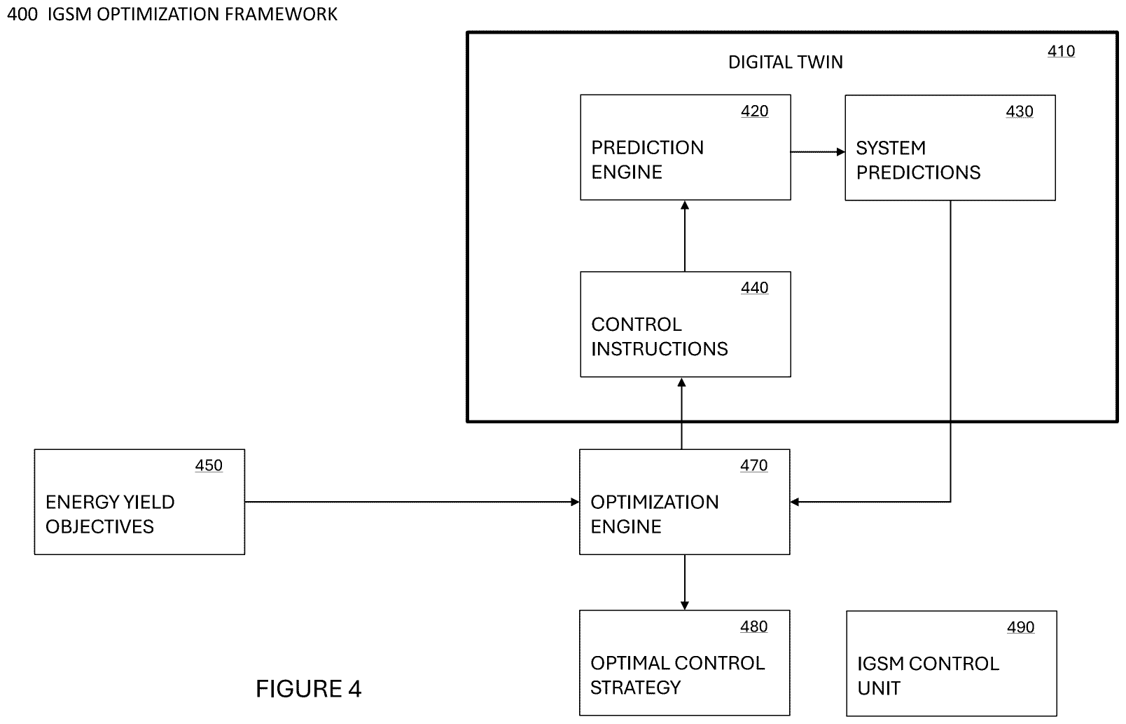

FIG. 4 illustrates an example IGSM optimization framework 400, according to some embodiments. In this framework, the optimization engine 470 is configured with energy yield objectives 450, including but not limited to peak shaving, time-of-use avoidance, energy resilience and reducing demand charges, and associated constraints and generates a set of IGSM control instructions 440. These instructions are used by the digital twin 410 to predict the system operation over the next 24 period using the models and operations simulation implemented in the prediction engine 420. The system predictions 430 are fed back into the optimization engine which in turn updates the control instructions 440 for another trial. The optimal set of control instructions are then stored and sent to the IGSM control unit 490 for execution.

Rank ordering and prioritization based on specified multiple energy yield objectives is now discussed.

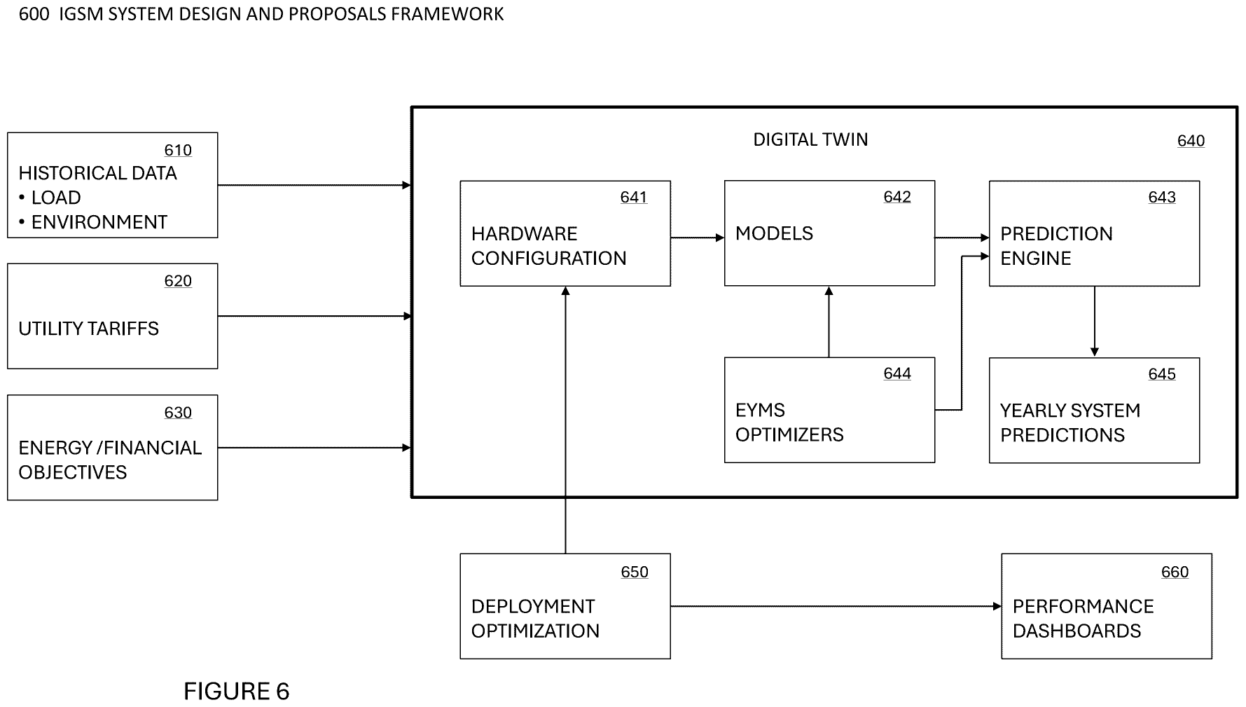

FIG. 6 illustrates the IGSM deployment optimization framework. The present platform's digital twin models (e.g. illustrated in FIG. 3) can simulate the system over a variety of quantity and type of individual components thereby providing results of experimental design algorithms. The platform may, in some embodiments, simulate interactions of the IGSM with existing energy generation and storage components 641, and include local energy objectives 630, 644 and utility tariff structures 620 to optimize a deployment structure to meet the microgrid's financial, environmental and energy yield objectives while identifying potential issues and improve the design before physical deployments are built. The system is configured with static historical 610 data (representing a year of local load consumption, and environmental data), utility tariff structure 620 and energy and financial yield optimization objectives and constraints 630.

Energy and financial yield optimization objectives 630 are configured and in some embodiments, multiple objectives prioritized. Objectives 630 are specified uniquely for each deployment ensuring optimal energy management meeting time-of-use energy reduction, peak shaving, demand charge reduction, energy resilience preparedness, cost reduction, demand response preparedness, GHG reduction, etc.

The deployment optimization algorithms 650 iteratively run computational steps provided by a digital twin 640 simulating each component 642 of IGSM operation for at least one year. Simulated data collection from historical data 610 and financial and energy yield optimization algorithms 644 are executed at every time step (typically 15-minute intervals). Analysis of the operational simulation results 645 is performed to create IGSM deployment operational and financial performance reports which can be displayed in rank order derived from the specified objects of energy yield, financial and GHG reduction priority in operator accessible dashboards 660.

The digital twin illustrated in FIG. 3 provides intelligence to actively monitor and learn how each power generating resource 340, control unit 142 performs under a variety of operational conditions and characteristics. Specifically, the present embodiment models solar photovoltaic power generation using an empirical or physical model such as, but not limited to, the Air Mass-Diffuse-Reflection (ADR) model, Huld model and PVWatts models, to represent a power generating resource's behavior or characteristics. It is noted that for reference, PVWatts can be a name of the software model created and used by NREL.

To develop the power generation models, the control units within IGSM or similar deployments (e.g. control unit 141, etc.) can regularly and continuously monitor and report the state of each power generating resource 142 under observation. A control unit 141 can include a real time communication and control processor installed within each IGSM deployment or similar microgrid or solar power generation facility.

In its simplest form, the state of the power generating resource 142 can be reported to the platform by a control unit 141 as instantaneous electrical power generation measured in kilowatts (kW) or as energy produced over a defined period measured in kilowatt-hours (kWh).

In concert with the capacity data monitoring of the power generating resource described above, the digital twin 310 can associate the power generation capacity data of each resource to the environmental data 330 collected by third party providers and the controller 141 from environmental sensors 144, 340 which can collect among other data, ambient temperature, humidity, wind speed and solar irradiance.

The observations of the control units 141, both historical and real time, can be used by the digital twin 310 to create resource specific models 311, 312 accessible by the optimization and predictive algorithms. Additionally, the models 312 are used for prescriptive maintenance algorithms discussed herein.

The models, 311, 312, are developed using known physical principles or empirical formulations. As new generation and environmental observations 330, 340 described above become available, the digital twin updates each resource's model parameters using Bayesian methods. This involves combining prior knowledge of the parameters with the new data to produce updated, or “posterior,” estimates.

The Bayesian approach allows for a systematic incorporation of uncertainty and improves the model's accuracy over time as more data is collected, reflecting the resource's behavior more precisely.

In addition, the digital twin provides algorithms 313 to simulate any combination of resource performance(s) under various environmental conditions, which together deliver the desired aggregate performance 315 and electrical management required to meet energy and financial objectives.

The system utilizes active resource modeling for the purposes of power generation prediction based upon weather and environmental forecasts, hardware degradation (long term performance changes due to hardware degradation) and localized immediate performance degradation (for example due to panel soiling).

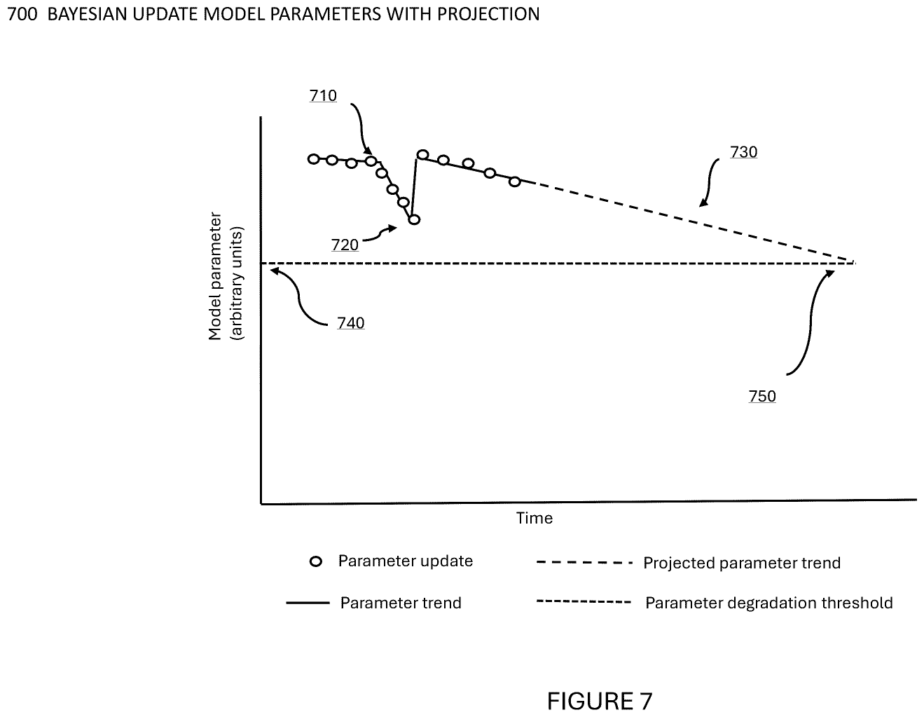

FIG. 7 is a diagram illustrating Bayesian update model parameters with projection, according to some embodiments. Accordingly, FIG. 7 illustrates this process of updating parameter distributions 710 with performance observations made over time. Shown are the interpretations of parameter variation, short term and long-term projections. Short term variations in parameter values are interpretable as changes in operational conditions. For example, short term variations in a PV generation resource model parameter 720 can be interpreted as performance degradation due to soiling. Such degradation of performance can be identified for each resource and will be utilized by the prescriptive maintenance component of the digital twin.

The system models the long-term trends of model parameters 730 which can be interpreted as overall degradation in the hardware's power generating capability and storage capabilities. Parameter value thresholds 740 are predetermined as indicative and requiring maintenance or replacement. The projection into the future 750 of the parameter trends enables determination of the time in the future when the resource is no longer operating at minimum capacity.

The resulting system provides for monitoring, control and maintenance planning over a dynamic portfolio that can change operational characteristics daily; such as operational changes due to weather conditions, security requirements, equipment performance and other factors.

Local load modeling is now discussed. Capacity for a local load is the amount of electricity, typically measured in megawatts (MW) or kilowatts (KW), that a traditional energy supply (plant) can create. Energy capacity for a local load is the amount of electricity consumed for a specified duration of time and is typically measured in megawatt-hours (MWh) or kilowatt-hours (kWh).

Local load capacity depends on the load type, such as office buildings, schools, commercial and industrial facilities, cell phone towers, inter alia. The load capacity required depends strongly on many external factors including but not limited to building occupation, environmental conditions (such as high ambient temperatures requiring increased cooling loads), time of the day, time of the week, time of the year, operational conditions, industrial process schedules, and many other impactors.

In the present embodiment, the platform develops time series energy consumption models employing the following methodologies.

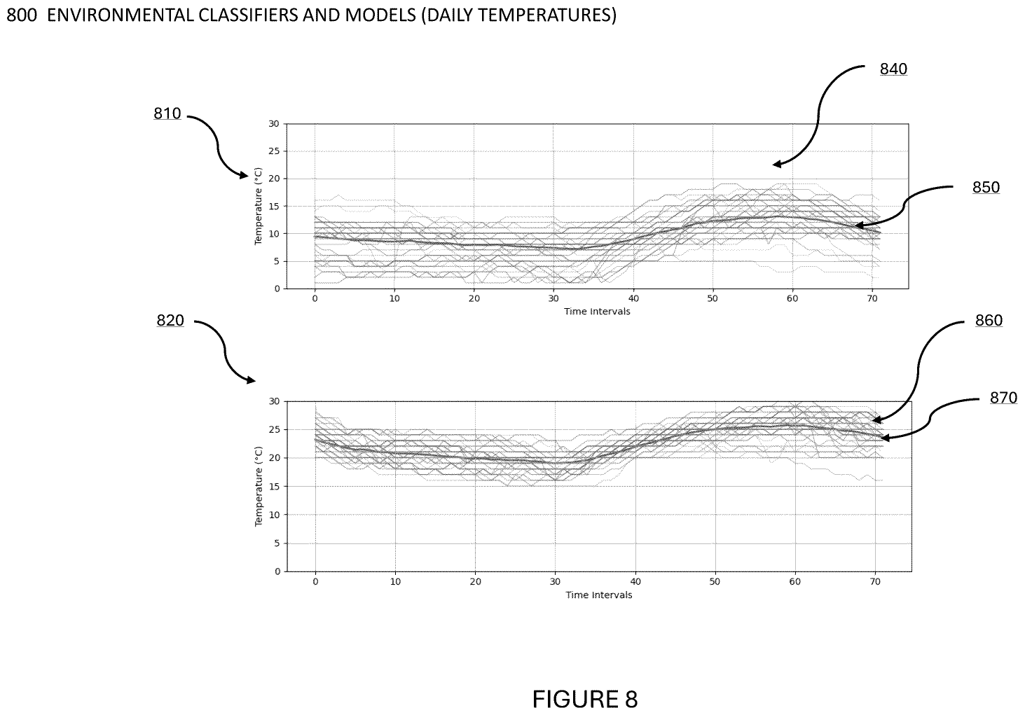

FIG. 8 illustrates an example modelling of environmental classifiers and model(s), according to some embodiments. As shown, FIG. 8 is an example embodiment of time series prediction methodology. Shown are two examples of the environmental classification results for daily temperatures, according to some embodiments. FIG. 8 is an illustration of an embodiment for a methodology for weather and environmental factors classified into different qualitative and quantitative groups. In some embodiments of this software, clustering weather patterns into cold, mild-cool, mild-warm and hot daily patterns based upon up to 20 years of local historical weather data 810, 820 is used to build classes of environmental conditions. In certain embodiments this may also include humidity data resulting in hot-humid, hot-dry, and similar daily patterns. In other embodiments of the platform, the models may also include data on cloud cover, precipitation, inter alia.

The classes of daily temperature profiles (among other data) are automatically discovered by the algorithm. However, it is intuitive to identify certain classes as “hot day” 820 or “cool day” 810 for example. Each classification is defined by the centroid profile 850, 870 and the contributing daily profiles. Given a forecast for the next 24 hours, the system can determine which class the environmental conditions can be assigned. This classification is then used for predicting data as a time series that depends upon the environmental factors.

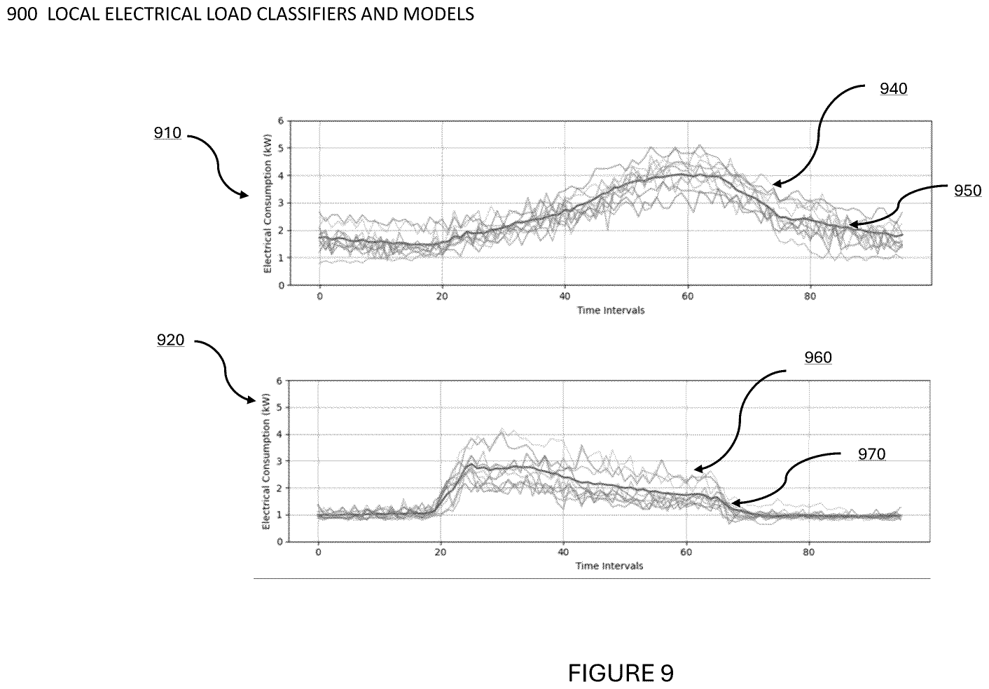

FIG. 9 illustrates an example modelling of local electrical load classifiers and model(s), according to some embodiments. Accordingly, FIG. 9 is an example of the invention's time series prediction methodology. Shown are two examples of the local load energy consumption profiles, according to some embodiments. This can be an illustration of local electrical load consumption classification. These profiles are further classified based upon environmental classes. Using machine learning algorithms, electrical loads are automatically clustered into daily patterns which can be from local electrical loads of commercial buildings, electrical equipment, and industrial facilities. This method automatically identifies differences in electrical energy requirements based upon occupation and human behavior at the site and can identify changes in occupation or operations depending on weekdays, weekends, holidays and similar. For example, 910 is a classification result from a “hot day”/“occupied” commercial building illustrating notably higher electrical energy consumption during the heat of the day (likely for air conditioning use). Further, 920 is a representation of expected load profiles for the same commercial building but on a “cool day”/“occupied” classification.

Each load pattern is further classified based upon the environmental and weather patterns determined in the environmental classification models described above 800. For each environmental classifier 850, 870, etc., load data 940, 960 is further segmented and classified based upon local operation, occupation and behavior 950, 970. Every model classification is described by a centroid profile 950, 970 and a time-based standard deviation around this centroid.

Predictions of a future 24-hour period, for example, of local energy consumption are calculated by selecting the most applicable models based upon current and forecasted environmental conditions and thus specified classification. Monte Carlo simulations, Kalman filter algorithms among other methodologies are used to predict time series profiles for local energy consumption using the classification, centroid and standard deviation as model inputs.

Continuous observations by the controller of the instantaneous load and environmental data enable model selection refinement and thus more accurate load predictions. Each observation 320, 330, typically made in 15 minutes intervals, is fed back into the platform 310 and the energy load model application to refine and update the predictions.

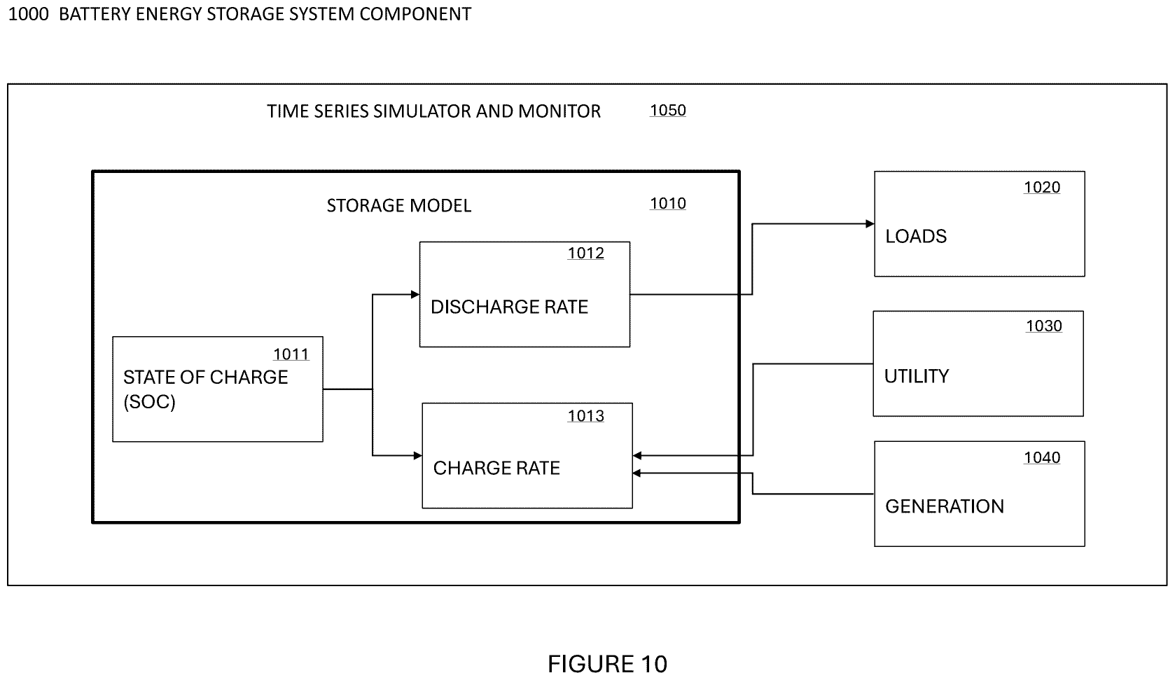

FIG. 10 illustrates an example battery energy storage system component, according to some embodiments. Battery energy storage system modeling is now discussed. Battery energy storage system components are illustrated in FIG. 10. Energy storage models 1010 are initialized with specifications and data provided by battery and battery energy storage system manufacturers. The models are updated using real time and long-term observation of performance of the battery energy storage systems. The models developed in the present digital twin are used to predict state of charge (SOC) 101 considering the discharge rate 1012, and charge rate 1013. Model parameters governing specifications such as C-Rate, capacity limits, operating temperature dependence, etc. are initialized from hardware specification and updated with real time observations. Additionally, the model supports the prescriptive maintenance component by calculating the state of health (SOH) 550 and remaining useful life (RUL) 560 of batteries and can be used to predict hardware performance degradation over time.

Tariffs are now discussed. Capacity for a local load is the amount of electricity, typically measured in megawatts (MW) or kilowatts (KW), that a traditional energy supply (e.g. a plant) can create. Energy capacity for a local load is the amount of electricity consumed for a specified duration of time and is typically measured in megawatt-hours (MWh) or kilowatt-hours (kWh).

Additionally, reduction in instantaneous demand, typically measured in kilowatts (KW), which would have been satisfied by a traditional energy supply. IGSM reduction of instantaneous demand equals a capacity that can be met by local IGSM produced or stored power and thus not required to be generated. In some examples, instantaneous demand charges can be fees imposed by utilities based on the highest level of electricity consumption (demand) recorded during a short time interval, typically within fifteen (15) minutes, in a billing period. These charges can reflect the peak load on the grid and incentivize customers to manage and reduce sudden spikes in energy usage.

Additionally, financial optimization incorporates the nuances of power and transmission utility billing structure and tariffs on power delivery and energy consumption enabling strategic reduction of grid-based power consumption by intelligent allocation of IGSM resources to local loads.

Example embodiments provide energy yield management algorithms 313 and 316 to mitigate the financial burden incurred by time-of-use and demand charges imposed by electric utilities. Time-of-use tariffs 350 are electricity pricing structures where the cost of electricity varies depending on the time of day, day of the week, and even the season. The idea is to incentivize consumers to shift their electricity usage to off-peak periods, when demand is lower and electricity is cheaper, and away from peak periods, when demand is high, and electricity is more expensive. Demand charges are additional fees on a consumer's electricity bill based on their highest level of power demand during a billing period, usually measured in kilowatts (KW). These charges are common in commercial and industrial electricity tariffs but are also increasingly applied to residential customers, especially those with high electricity usage or those using renewable energy systems.

From an energy management perspective, the application of one or more prioritized energy yield objectives 450 including but not limited to peak shaving, time-of-use avoidance and reducing demand charges represent an innovative method for optimizing energy consumption and lowering operational costs in electrical systems. This method involves the strategic management of energy loads to minimize peak demand periods, which are defined as the intervals when electricity consumption reaches its highest level within a billing cycle or when utility tariffs are at their peak level. By deploying automated systems of digital twin 300, an optimization framework 316 sends a specific set of instructions to control instructions 314 enabling a change in the operating status of energy storage, or alternative power sources. The IGSM, according to the sent instructions, dynamically adjusts energy usage to avoid these peaks, thereby reducing the demand charges levied by utility providers. This approach not only results in cost savings by mitigating the impact of demand charges, but it also enhances the overall efficiency and sustainability of energy usage within an industrial or commercial setting.

Green House Gas (GHG) Emissions are now discussed. In some embodiments of this invention, the environmental, social and governance (ESG) objectives for customers are the primary incentive for deploying IGSM or similar. The environmental criterion assesses how a company manages its environmental impact. Key factors can include among others: carbon or greenhouse gas (GHG) emissions, energy consumption, resource use and conservation. The present platform has algorithms to calculate the projected GHG reduction for a set of proposed designs of IGSM deployments, including renewable power generation, energy storage, and load profiles enabling customers to deploy optimal system configurations.

Capacity for greenhouse gas emissions is the quantitative measurement of pollutants, typically given in metric tons of CO2 equivalent (CO2e), that a source or activity, such as a power plant or industrial process, can release into the atmosphere. The present software embodiment manages energy yields of IGSM power resources locally to quantitatively calculate reduction in greenhouse gas emissions and minimize reliance on centralized, fossil fuel-based power plants and maximizing the use of renewable energy sources which produce little to no emissions.

Demand Response is now discussed. An example software embodiment can be configured to IGSM deployments can offer substantial financial benefits by reducing energy costs through local generation and storage, enhancing energy efficiency, and providing opportunities for revenue generation through demand response programs.

Demand response programs are initiatives designed to encourage consumers to reduce or shift their electricity usage during peak demand periods or when the grid is stressed. By offering incentives or pricing adjustments, these programs help balance supply and demand, improve grid reliability, and potentially lower energy costs for participants.

In some embodiments, the present platform can connect through cloud-based services or utility APIs to receive and act on demand response signals and can accurately calculate in real-time the contribution made to the program thus eliminating the need for reconciliation at the end of a billing period.

Resilience is now discussed. IGSM or similar deployments improve energy resilience by ensuring a reliable supply of power, even during grid disturbances or outages, which is especially crucial for critical infrastructure.

Example embodiments manage and maintain energy resilience as an optional objective 350 provided to the EYMS and optimization engine 470. The IGSM control software receives instructions from the system to enable rapid response to fluctuations in solar irradiation, energy supply and demand, and ensuring reliable power delivery even during disruptions or outages in the main grid.

Energy resilience assurance is defined by the amount of energy in reserve found both in local IGSM or similar renewable power generation and battery storage capacities. This reserve capacity must be enough to meet local demand for a specified period (e.g. 48 hours of operation).

To ensure local energy resilience, the present embodiment of the platform calculates on a predefined interval (e.g. every 15 minutes, etc.), the future load requirements and generation potential from renewable IGSM resource.

The load and generation predictions along with the capacity of the battery storage system are fed into the platforms energy yield optimization algorithms with dynamic constraints set to the minimum state of charge for the battery energy storage system.

This minimum state of charge is determined to be capable of providing necessary energy for the required time period. The present embodiment of the platform maintains this minimum state of charge by dynamically controlling the operation control parameters sent to the IGSM or similar control units.

AI prescriptive maintenance is now discussed. Prescriptive maintenance framework 500 can provide the software components of the invention's artificial intelligence (AI) prescriptive maintenance framework. Digital twin 510 modeling of the IGSM and all its sub-components is crucial for prescriptive maintenance as it enables real-time simulation, forecast modeling and analysis of the microgrid's performance, allowing for early detection of potential issues and scheduling of corrective and proactive maintenance. This predictive approach using machine learning and artificial intelligence helps minimize downtime, reduce maintenance costs, and extend the lifespan of the microgrid components.

Some of the required maintenance activities are determined from analysis of the time-varying parameters of each resource model and are described in terms of the resource's state of health 550 and/or the resource's remaining useful life 560. The prediction engine 540 for each component uses resource models 520, 530 and generates present values and future predictions of SOH and RUL, for as long as 30 years of operation. Short and long-term resource degradation is extracted from the models. For example, short term deviations in specific parameters in the PV panel model are interpreted as intermittent issues such as PV panel soiling.

An AI scheduler is now discussed. Longer term parameter variations using machine learning and artificial intelligence (AI) can be extracted from real time model updates and trended into the future as illustrated in FIG. 7. The trends are indicative of hardware replacement or upgrade requirements as they track and monitor degradation in hardware performance. Each resource has its own model from which the state of health 550 and remaining useful life 560 features can be calculated.

In aggregate of all resources across all deployments of a fleet, the totality of required maintenance activities as determined by model predictions are input into maintenance scheduling optimizers 570. The AI maintenance field service schedule optimizations algorithms use geographic locations, required skills and tradesmen 580 and model predictions 550 and 560 to generate preventive and corrective maintenance plans 590 enabling minimization of resource downtime and redundant labor and tradesmen site visits, as an example.

Energy yield performance metrics are now discussed. Performance metrics for microgrid energy yield are crucial for evaluating the efficiency, reliability, and overall effectiveness of a microgrid system. Example embodiments track the predicted performance metrics for a minimum of a 24-hour period which is used to determine the optimal control instructions for IGSM or similar deployments. The predicted performance is stored along with real-time observation of IGSM performance. Comparison of achieved performance versus the predicted operation provides insights into the successful operation of EYMS controlling IGSM or similar.

Energy performance metrics which are calculated, tracked and verified include, but may not be limited to: energy yield (total amount of energy produced by the IGSM over a specified period), capacity factor (ratio of the actual energy produced by the IGSM to the maximum possible energy it could produce if operated at full capacity all the time), load factor (ratio of the average load or actual energy demand to the peak load over a period), energy efficiency (ratio of the useful energy output to the total energy input, accounting for losses in generation, storage, and distribution), renewable energy penetration (proportion of the total energy yield that comes from renewable sources within the IGSM), system availability (the percentage of time the IGSM is operational and capable of producing energy), power quality (measure of the stability and reliability of the voltage and frequency of the electricity produced by the IGSM), storage utilization rate (percentage of the energy storage system's capacity that is used during a period), grid independence (the ability of the microgrid to operate independently of the main grid, including the duration and reliability of this operation), economic performance (evaluation of the financial return on investment for the microgrid, including cost savings and revenue generation), carbon footprint reduction (the amount of carbon emissions avoided by using the microgrid compared to traditional energy sources), energy resilience (the ability of the microgrid to maintain energy supply during disruptions or adverse conditions), demand response efficiency (the microgrid's effectiveness in adjusting its energy production or consumption in response to changes in demand or grid signals), peak shaving efficiency (the effectiveness of the microgrid in reducing peak demand, thereby lowering energy costs and improving grid stability), energy curtailment rate (the percentage of potential energy generation that is not utilized due to system constraints or excess production), and energy arbitrage (the practice of buying or storing energy when prices are low e.g., during off-peak hours, and selling or using it when prices are high e.g., during peak hours).

The integrated system for microgrid performance metrics is designed to generate comprehensive reports and dashboards tailored for financial stakeholders, emphasizing high-level performance tracking and decision-making.

The system aggregates historical, real-time, and projected data to provide a holistic view of the microgrid's operations. Key performance indicators (KPIs) such as energy yield, capacity factor, and carbon footprint reduction are continuously updated and analyzed. Predictive algorithms refine future performance projections, offering insights into trends and potential impacts on financial outcomes.

Customizable reports are generated at regular intervals, highlighting critical metrics that matter most to financial stakeholders. These reports include visual representations of the microgrid's energy production, efficiency, and economic performance over time. Financial metrics, such as cost savings, return on investment (ROI), and net present value (NPV), are prominently featured, providing clear insights into the financial health and sustainability of the microgrid.

Dynamic dashboards are designed to present real-time data and projections in an accessible format. These dashboards offer an at-a-glance view of the most important metrics, allowing stakeholders to quickly assess the microgrid's performance. Features such as trend analysis, scenario modeling, and alert systems enable proactive management decision-making, well in advance of when the actions need to be taken.

Financial performance measurement is now discussed. Financial performance metrics of energy which are calculated, tracked and verified include, but may not be limited to, multiple on invested capital (MOIC), internal rate of return (IRR), savings to investment ratio (SIR), payback period, benefits from financial Incentives and savings on use of energy relative to other sources.

These metrics are dynamically calculated at least once a day, projecting out for the life of each project up to 30 years. They are also aggregated from the site level up to the fleet.

Due to the nature of sequential deployments over time, certain embodiments of the systems will start with the inception date of the earliest project and continue to extend for up to 30 years into the future from the latest project, thereby providing a dynamically updated evaluation view to the stakeholders and decision makers, across the multiple metrics, so they can monitor, measure and manage based on local conditions.

Dashboards and reports focus on tracking the microgrid's performance against set targets, with emphasis on financial metrics that resonate with stakeholders. Insights into how the microgrid is contributing to cost savings, energy efficiency, and environmental goals are provided, helping stakeholders understand the broader impact of their investment. The system also offers tools for scenario analysis, enabling stakeholders to explore the financial implications of different operational strategies or external factors, such as changes in energy prices or regulatory policies.

Scalability is now discussed. An example software embodiment enables scalability of additional, multiple IGSM or similar deployments which for single customers are aggregated into fleets.

Each power generating, storage, security and load resource and energy consumption points are individually monitored and modeled. Monitored, predicted and calculated features such as but not limited to financial performance, generation capacity, load consumption capacity, and operational details are aggregated from individual deployments and resources into a comprehensive fleet level view and dashboard summaries. This methodology provides operators interested in fleet-wide financial and operation performance a complete view into all deployments.

Non-transitory computer program products (e.g. physically embodied computer program products) are also described that store and execute instructions, which when executed by one or more data processors of one or more computing systems, causes at least one data processor to perform operations herein. Similarly, computer systems are also described that may include one or more data processors and memory couple to the one or more data processors. The memory may temporarily or permanently store data or instructions that cause at least one processor to perform one or more of the operations described herein. In addition, methods can be implemented by one or more data processors either within a single computing system or distributed among two or more computing systems. Such computing systems can be connected and can exchange data and/or command or other instructions or the like via one or more connections, including but not limited to a connection over a network (e.g. the internet, a wireless wide area network, or the like), via a direct connection between one or more of the multiple computing systems, etc.

The subject matter described herein provides many advantages that are now described by way of example and not of limitation. For example, the subject matter herein provides a site or building owner or operator with much finer control and verification of energy yield management events as scheduled for day ahead actions or at the time they are occurring. This control is accomplished in part, by providing a platform that provides data collection, data monitoring, analysis, optimization and instructions to resources, and the verification of status for each end resource (e.g. load, generation or storage, etc.) in real time.

The subject matter herein additionally provides the building owner or operator a means to identify, define and verify individual or aggregated financial, energy yield and/or greenhouse gas emission targets through which real time optimization algorithms generate updated instructions to selected resources. The subject matter herein provides the owner or operator direct control and monitoring of energy yield management operations within a plurality of IGSM systems. The status, generation, storage and consumption contribution of each individual resource at a site or plurality of sites are monitored, controlled and aggregated by the platform for presentation to the site owner or operator at any time. The platform continuously monitors and adjusts, effecting control over energy yield resources, (e.g., consumption and storage).

A machine learning engine can utilize machine learning algorithms to recommend and/or optimize various peer-to-peer delivery services. Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning. Random forests (RF) (e.g. random decision forests) are an ensemble learning method for classification, regression and other tasks, which operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, that is a set of examples used to fit the parameters (e.g. weights of connections between neurons in artificial neural networks) of the model. The model (e.g. a neural net or a naive Bayes classifier) is trained on the training dataset using a supervised learning method (e.g. gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g. the number of hidden units in a neural network). Validation datasets can be used for regularization by early stopping: stop training when the error on the validation dataset increases, as this is a sign of overfitting to the training dataset. This procedure is complicated in practice by the fact that the validation dataset's error may fluctuate during training, producing multiple local minima. This complication has led to the creation of many ad-hoc rules for deciding when overfitting has truly begun. Finally, the test dataset is a dataset used to provide an unbiased evaluation of a final model fit on the training dataset. If the data in the test dataset has never been used in training (e.g. in cross-validation), the test dataset is also called a holdout dataset.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed:

1. A computerized system of an Energy Yield Management Software (EYMS) framework comprising:
an Industrial Grade Solar Microgrids (IGSM) deployment comprising a control unit configured to communicate with a power generating source, collect data from the power generating source, and issue instructions to the power generating resource, wherein the control unit is further configured to communicate with a sensor, an automation module, a local load, an energy storage systems, or a generation resource within a customer IGSM deployment;
wherein the EYMS is configured to communicate through a communication network to the IGSM deployment;
a Digital Twin configured to actively use real time and historical data to learn how each component in the IGSM performs under a plurality of operational conditions and characteristics, wherein a predictive model is employed by the Digital Twin for a prediction operation, an optimization operation and a prescriptive maintenance operation of the IGSM.

2. The computerized system of claim 1, wherein the EYMS framework comprises a real time Industrial Grade Solar Microgrids (IGSM) deployment.

3. The computerized system of claim 2, wherein the power generating resource comprises a solar PV system.

4. The computerized system of claim 2, wherein the power generating resource comprises a hydrogen fuel cell.

5. The computerized system of claim 2, wherein the power generating resource comprises any equipment location served by an electrical grid and an energy storage system.

6. The computerized system of claim 5, wherein the energy storage system comprises a battery energy storage system.

7. The computerized system of claim 6, wherein the local load is located at a point beyond a customer meter used by a utility.

8. The computerized system of claim 7, wherein the control unit comprises at least one processor and memory storing instructions causing data to be transmitted to one or more connected resources to cause a transfer of energy between a grid, a local renewable power generation source, a local energy storage and local energy demand to selectively change.

9. The computerized system of claim 8, wherein the Digital twin models a plurality of features classification algorithms which allocate daily environmental and load consumption data into a set of distinct classifications and patterns.
